(19) United States
(12) Patent Application Publication
(10) Pub. No.: US 2011/0054074 A1
(43) Pub. Date: Mar. 3, 2011

(54) ADHESIVE

(75) Inventors: Gerhard Jonschker, Heppenheim (DE); Reiner Friedrich, Seeheim (DE); Joerg Pahnke, Darmstadt (DE)

(73) Assignee: Merck Patent Gesellschaft Mit Beschrankter Haftung

(21) Appl. No.: 12/989,134

(22) PCT Filed: Apr. 3, 2009
(86) PCT No.: PCT/EP09/02492

§ 371 Date: Oct. 22, 2010

(30) Foreign Application Priority Data
Apr. 23, 2008 (DE) 10 2008 020 441.2

(51) Int. Cl. C09J 163/00; C09J 175/04

(52) U.S. Cl. 523/400; 524/265

(57) ABSTRACT

The present invention relates to an adhesive comprising at least one matrix material and core/shell particles comprising cores having a diameter in the range from 1 nm to 1 μm with a shell comprising oligomers and/or polymers, and to a process for the preparation thereof.

The invention relates to an adhesive comprising core/shell particles, to a process for the preparation thereof, and to the use of core/shell particles as additive for adhesives.

According to DIN EN 923: 2006-01, adhesives are non-metallic substances which connect joint parts by adhesion and cohesion. According to Römpp Chemielexikon [Römpp's Lexicon of Chemistry], adhesives are predominantly based on organic compounds and can be divided into various types of adhesive: physically setting (glues, pastes, solvent, dispersion, plastisol and hot-melt adhesives) and chemically setting (for example cyanoacrylate adhesives). The physically setting adhesives can be solvent-free (hot-melt adhesives) or solvent-containing. They set through a change in the physical state or through evaporation of the solvents before or during the bonding process and generally comprise one component. The chemically setting, one- or multicomponent reaction adhesives can be based on all polyreactions: two-component systems comprising epoxy resins and acid anhydrides or polyamines react by polyaddition mechanisms, cyanoacrylates or methacrylates react by polymerisation mechanisms, and systems based on amino resins or phenolic resins (see phenolic resins) react by polycondensation mechanisms. The most modern class of adhesives comprises the polyurethane adhesives. Silicones and silane-crosslinking polymers are also used as adhesives. Most reaction adhesives are mixed from two components, the actual base material and the curing agent or activator. The range of monomers or polymers which can be employed as adhesive raw materials is wide and variable. For the purposes of the present invention, adhesives are additionally taken to mean casting compositions and raw materials for the preparation of fibre-reinforced plastics.

A common feature of all these applications is that the adhesive polymer makes a crucial contribution to the applicational and mechanical properties of the bond formed. A multiplicity of problems exists which cannot be solved through the choice of a polymer or monomer alone, but instead make it necessary to add additives to the polymer. These are selectively, without any claim to completeness:
reduction in shrinkage during curing
adhesion to a very wide variety of substrates
very different coefficient of expansion between polymer and bonded parts
impact strength at the same time as high hardness
prevention of catastrophic crack propagation in the bond, for example on sudden loading
high Tg
jump in the mechanical properties of the bond when the Tg of the polymer is exceeded
temperature resistance (decomposition temperature)
chemical resistance
ageing due to environmental influences (for example UV radiation)

Additives which are nowadays added to polymers in order to address some of these problems are, for example, inorganic particles, silicone particles, silicone (block) copolymers, carbon nanofibres, glass powders or organo-functional silanes.

A characteristic feature of all products known today is that they each only exert one mechanism of action, such as, for example, the nanoparticles, which, as filler, reduce shrinkage, and the silicone particles, which improve the elasticity and inhibit crack propagation. If it is desired to address a plurality of problems, different approaches must be combined with one another and two or more additives must be added to the polymer.

In general, the use of additives of any type in polymers is undesired since the complexity and thus the susceptibility of the system to flaws increases.

For each additive, on the one hand the dispersibility and long-term stability in the polymer must be assured, but the compatibility and joint efficacy with all other substances must also be ensured.

Thus, incompatibilities and neutralisation of the action may typically occur. Furthermore, the additional complexity of storage and production is disadvantageous to the user, where a cost disadvantage due to the purchase of a plurality of raw materials can also be assumed.

Accordingly, the present invention was based on the object of providing an adhesive in which various applicational advantages can be achieved by an additive. The present invention therefore relates to an adhesive comprising at least one matrix material and core/shell particles comprising cores having a diameter in the range from 1 nm to 1 μm with a shell comprising oligomers and/or polymers.

The present invention furthermore relates to fibre-reinforced plastics in which an adhesive according to the invention serves as adhesion promoter between the fibres. Corresponding fibres can be all fibres which are conventional in the art for reinforcement, where asbestos, boron fibres, carbon fibres, metal fibres, synthetic fibres and glass fibres are preferred. Carbon fibres and glass-fibre-reinforced plastics, in particular, belong to the preferred materials.

Preferred shell materials here are elastic oligomers or polymers.

Matrix materials which can be employed in accordance with the invention are usually polymeric or oligomeric materials or corresponding polymerisable monomers.

In preferred embodiments of the present invention, the use of the core/shell particles as additive in the adhesive, which is likewise a subject-matter of the present invention, enables various problems in adhesive/composite materials technology to be addressed simultaneously:
The core can act as nanofiller and can reduce shrinkage.
The elastic shell can act as impact modifier and thus improve the fracture toughness of the polymer.
The elastic spherical shell directly on the nanofiller may make it possible to select a very much smaller amount of elastic polymer than by means of, for example, rubber particles, which are currently only available on the market in sizes >100 nm. The elastic polymer can thus be introduced into the polymer much more homogeneously than through conventional fillers.
The elastic suspension of the nanofillers in the polymer enables bonding thereof in the polymer to be improved and the action as reinforcing filler to be improved further.
Reactive groups on the polymer shell can react with the adhesive polymer and ensure secure bonding. The positioning on the flexible polymer chain and not, as in the case of simply silanised particles, directly on the particle surface also guarantees steric accessibility and reactivity.
Covalently bonded inorganic cores enable an increase in the Tg of the composite and a reduction in the sudden worsening of the mechanical properties when the Tg is exceeded.
Cores having UV-absorbent properties enable the ageing resistance to be improved (for example through ZnO, CeO₂, TiO₂).
The adhesive can be provided with IR-absorbent properties by using, for example, ITO (indium-doped tin oxide) or ATO (antimony-doped tin oxide) or compositions with a similar action as the core.
The chemical resistance of the adhesive can be improved by the inorganic content of the core.
Magnetic cores enable the adhesive to be provided with paramagnetic or superparamagnetic properties. Iron oxides, for example, can be used here.
The diffusion of O₂, water or other substances through the adhesive can be hindered/slowed by core/shell particles, in particular having a flat structure.

For the purposes of the present invention, an “adhesive” is taken to mean a material which is employed for the temporary or permanent bonding of substrates. In particular, the term “adhesive” for the purposes of the present text is taken to mean hot-melt adhesives, dispersion adhesives, pressure-sensitive adhesives, hot-melt/pressure-sensitive adhesives, reactive adhesives, and casting compositions and the like.

Adhesives according to the invention preferably comprise, as matrix material, at least one synthetic inorganic polymer/oligomer or natural organic polymer/oligomer, as occurs in nature or can be obtained from natural products. Also suitable for the purposes of the present invention are adhesives which comprise a mixture of one or more synthetic organic polymers/oligomers and one or more natural organic polymers/oligomers.

The synthetic organic polymers/oligomers as are employed in a preferred embodiment of the present invention include, for example, polyesters, polyethers, polyamides, polyurethanes, polyacrylates, polymethacrylates, polyvinyl acetate, ethylene-vinyl acetate copolymers, propylene-vinyl acetate copolymers, styrene-acrylate and styrene-methacrylate copolymers and the like. Alternatively, the adhesives may, as mentioned above, also comprise corresponding monomers as matrix material. Various polymers are described in greater detail below, where the term polymer in each case encompasses the respective oligomers or monomers as matrix material. The adhesive according to the invention can be a hot-melt adhesive or a dispersion adhesive in an embodiment as pressure-sensitive adhesive or as contact adhesive or as reactive adhesive.

The adhesive according to the invention can be employed, for example, as hot-melt adhesive. For the purposes of the present invention, “hot-melt adhesives” are taken to mean adhesives which are solid at room temperature and are at least substantially water- and solvent-free. Hot-melt adhesives are applied from the melt and set physically on cooling with solidification. Suitable hot-melt adhesives are, for example, organic polymers, such as polyesters, polyurethanes, polyamides, polyalkylene oxides or addition polymers, for example ethylene-vinyl acetate copolymers, or mixtures of two or more of the said polymers, or compositions comprising one of the said polymers or a mixture of two or more thereof.

For the purposes of the present invention, the hot-melt adhesives employed can be, for example, polyurethanes.

Polyurethanes as can be employed as hot-melt adhesive for the purposes of the present invention are usually prepared by reaction of at least one polyisocyanate, preferably a diisocyanate, and a polyol component, which preferably predominantly consists of diols. The polyol component here may comprise only one polyol, but it is also possible to employ a mixture of two or more different polyols as the polyol component. Polyalkylene oxides, for example, are suitable as the polyol component or at least as a constituent of the polyol component.

If desired, some of the polyalkylene oxide may be replaced by other hydrophobic diols containing ether groups which have molecular weights of 250 to 3000, preferably 300 to 2000, in particular 500 to 1000. Specific examples of such diols are: polypropylene glycol (PPG), polybutylene glycol, polytetrahydrofuran, polybutadienediol and alkanediols having 4 to 44 C atoms. Preferred hydrophobic diols are polypropylene glycol, polytetrahydrofuran having a molecular weight of 500 to 1000 and 1,10-decanediol, 1,12-dodecanediol, 1,12-octadecanediol, dimeric fatty acid diol, 1,2-octanediol, 1,2-dodecanediol, 1,2-hexadecanediol, 1,2-octadecanediol, 1,2-tetradecanediol, 2-butene-1,4-diol, 2-butyne-1,4-diol, 2,4,7,9-tetramethyl-5-decyne-4,7-diol and ethoxylation products thereof, in particular with up to 30 mol of ethylene oxide.

Besides the diols of the polyol component, diisocyanates are essential building blocks of the polyurethane which can be employed as hot-melt adhesive. These are compounds of the general structure O═C═N—X—N═C═O, where X is an aliphatic, alicyclic or aromatic radical, preferably an aliphatic or alicyclic radical having 4 to 18 C atoms.

Examples of suitable isocyanates which may be mentioned are 1,5-naphthylene diisocyanate, 4,4′-diphenylmethane diisocyanate (MDI), hydrogenated MDI (H12MDI), xylylene diisocyanate (XDI), tetramethylxylylene diisocyanate (TMXDI), 4,4′-diphenyldimethylmethane diisocyanate, di- and tetraalkylenediphenylmethane diisocyanate, 4,4′-dibenzyl diisocyanate, 1,3-phenylene diisocyanate, 1,4-phenylene diisocyanate, the isomers of tolylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, 4,4′-diisocyanatophenylperfluoroethane, tetramethoxybutane 1,4-diisocyanate, butane 1,4-diisocyanate, hexane 1,6-diisocyanate (HDI), dicyclohexylmethane diisocyanate, cyclohexane 1,4-diisocyanate, ethylene diisocyanate, bisisocyanatoethyl phthalate, furthermore diisocyanates containing reactive halogen atoms, such as 1-chloromethylphenyl 2,4-diisocyanate, 1-bromomethylphenyl 2,6-diisocyanate, 3,3-bischloromethyl ether 4,4′-diphenyl diisocyanate.

Sulfur-containing polyisocyanates are obtained, for example, by reaction of 2 mol of hexamethylene diisocyanate with 1 mol of thiodiglycol or dihydroxydihexyl sulfide. Further diisocyanates which can be employed are, for example, trimethylhexamethylene diisocyanate, 1,4-diisocyanatobutane, 1,12-diisocyanatododecane and dimeric fatty acid diisocyanate. The following are particularly suitable: tetramethylene diisocyanate, hexamethylene diisocyanate, undecane diisocyanate, dodecamethylene diisocyanate, 2,2,4-trimethylhexane diisocyanate, 1,3-cyclohexane diisocyanate, 1,4-cyclohexane diisocyanate, 1,3- and 1,4-tetramethylxylene diisocyanate, isophorone diisocyanate, 4,4-dicyclohexylmethane diisocyanate and lysine ester diisocyanate. Tetramethylxylylene diisocyanate (TMXDI), in particular the m-TMXDI from Cyanamid, is very particularly preferred.

In order to increase the molecular weight further, a chain extension can be carried out, for example, in a known manner. To this end, firstly prepolymers containing excess diisocyanate are prepared, and then subsequently extended using short-chain amino alcohols, diols or diamines or using water with an increase in the molecular weight.

However, the polyurethane is preferably prepared in a one-step process, in which, for example, firstly all starting materials are mixed in the presence of an organic solvent at a water content of less than 0.5% by weight. The mixture is heated at 80 to 200° C., in particular at 100 to 180° C. and preferably at 130 to 170° C., for about 1 to 30 hours. The reaction time can be shortened through the presence of catalysts. In particular, it is possible to use tertiary amines, for example triethylamine, dimethylbenzylamine, bisdimethylaminoethyl ether and bismethylaminomethylphenol. Particularly suitable are 1-methylimidazole, 2-methyl-1-vinylimidazole, 1-allylimidazole, 1-phenylimidazole, 1,2,4,5-tetramethylimidazole, 1-(3-aminopropyl)imidazole, pyrimidazole, 4-dimethylaminopyridine, 4-pyrrolidinopyridine, 4-morpholinopyridine or 4-methylpyridine. However, the reaction is preferably carried out without a catalyst. The solvent is also advantageously omitted. For the purposes of the present text, “solvents” are taken to mean inert organic liquid substances having a boiling point of less than 200° C. at atmospheric pressure.

If the adhesive according to the invention is intended to be a dispersion adhesive, it comprises, in a preferred embodiment, a synthetic organic polymer selected from the group consisting of polyacrylates, polymethacrylates, polystyrene, polyvinyl esters, ethylene-vinyl acetate copolymers or acrylate-styrene copolymers. In a further preferred embodiment of the invention, the adhesive according to the invention is a dispersion adhesive.

If the adhesive according to the invention is a reactive adhesive, it consists, in a preferred form, of at least two components, which react chemically with one another after intimate mixing, forming a strong bond (generally a thermoset). Typical components could be, for example, OH-, SH-, NH- COOH-containing polyacrylates, polymethacrylates, polyesters, polyethers or copolymers or corresponding monomers/oligomers which are crosslinked by means of NCO-containing curing agents or COOH-, SH- or NH-functional polymers/oligomers/monomers which are crosslinked by means of epoxide-containing components.

One-component reactive adhesives preferably contain unsaturated groups or epoxide groups, which can be cured photochemically by methods known to the person skilled in the art or have a crosslinking mechanism corresponding to the 2-component adhesives, in which at least one component is in a temporarily blocked form or in the form of an inactive precursor and can be activated in a targeted manner.

The adhesive according to the invention may comprise a natural organic polymer or a mixture of two or more thereof instead of or in addition to one or more synthetic organic polymers. “Natural organic polymers” are taken to mean polymers as can be obtained from natural products by simple chemical operations. For the purposes of the present invention, the term furthermore also encompasses simple derivatives of natural organic polymers, for example the esterification or alkoxylation derivatives of starch or cellulose. In a preferred embodiment of the present invention, the adhesive according to the invention comprises the particles in an amount of 0.1 to 90% by weight, preferably in an amount of 1 to 30% by weight, in particular 2 to 20% by weight.

Irrespective of the specific type of adhesive, it is preferred for the matrix material to be a polymer selected from the group consisting of polyacrylates, polymethacrylates, polyoxyalkylenes, polyurethanes, polyesters, polyepoxides, polystyrene, polyethylene, polyvinyl esters, ethylene-vinyl acetate copolymers, or a mixture of two or more thereof, or correspondingly polymerisable monomers or oligomers thereof. Particularly preferred matrix materials are polyoxyalkylenes, in particular polyepoxides, and polyurethanes.

In the case of the epoxide-based adhesives or sealants, it is preferred for them to be in the form of two components, where a component A consists of or comprises one or more epoxide(s) and a second component B consists of or comprises one or more curing agents for epoxides. These two components are mixed with one another immediately before application. For the purposes of the present invention, suitable epoxides and curing-agent systems are those which are usually employed as adhesives or sealants in the art. Components A and B are preferably composed in such a way that equal volumes can be mixed for application.

In the case of 2-component systems, a preferred embodiment consists in that component B comprises the core/shell particles to be employed in accordance with the invention. It is particularly preferred for the shell of the particles to carry at least two terminal functional groups, which are selected from —OH groups, —SH groups and —NHR groups, where R denotes hydrogen or an organic radical having 1 to 12 C atoms. These functional groups correspond to typical functional groups in curing-agent systems and are able to react with the epoxide component A with opening of the oxirane ring and adduction of the organic molecule.
Another preferred embodiment consists in that component A comprises the core/shell particles to be employed in accordance with the invention. In this variant, it is preferred for the shell to carry epoxide groups as functional groups. Thus, the particles are able to react with the curing-agent molecules of component B with opening of the oxirane ring and adduction of the organic molecule.

However, the adhesives or sealants according to the invention may also be in the form of one-component systems which comprise epoxy resins and activatable or latent curing agents.

Suitable epoxy resins are a multiplicity of polyepoxides which have at least two 1,2-epoxy groups per molecule. The epoxide equivalent of these polyepoxides can vary between 150 and 4000. The polyepoxides can basically be saturated, unsaturated, cyclic or acyclic, aliphatic, alicyclic, aromatic or heterocyclic polyepoxide compounds. Examples of suitable polyepoxides include the polyglycidyl ethers, which can be prepared by reaction of epichlorohydrin or epibromohydrin with a polyphenol in the presence of alkali. Polyphenols which are suitable for this purpose are, for example, resorcinol, pyrocatechol, hydroquinone, bisphenol A (bis(4-hydroxyphenyl)-2,2-propane), bisphenol F (bis(4-hydroxyphenyl)methane), bis(4-hydroxyphenyl)-1,1-isobutane, 4,4′-dihydroxybenzophenone, bis(4-hydroxyphenyl)-1,1-ethane, 1,5-hydroxynaphthalene.

Further polyepoxides which are suitable in principle are the polyglycidyl ethers of polyalcohols or diamines. These polyglycidyl ethers are derived from polyalcohols, such as ethylene glycol, diethylene glycol, triethylene glycol, 1,2-propylene glycol, 1,4-butylene glycol, triethylene glycol, 1,5-pentanediol, 1,6-hexanediol or trimethylolpropane.

Further polyepoxides are polyglycidyl esters of polycarboxylic acids, for example reactions of glycidol or epichlorohydrin with aliphatic or aromatic polycarboxylic acids, such as oxalic acid, succinic acid, glutaric acid, terephthalic acid or dimeric fatty acid. Further epoxides are derived from the epoxidation products of olefinically unsaturated cycloaliphatic compounds or from native oils and fats.

Very particular preference is given to the epoxy resins which are derived by reaction of bisphenol A or bisphenol F and epichlorohydrin. In general, mixtures of liquid and solid epoxy resins are employed here, where the liquid epoxy resins are preferably based on bisphenol A and have a sufficiently low molecular weight. In particular, use is made of epoxy resins which are liquid at room temperature, which generally have an epoxide equivalent weight of 150 to about 220, particularly preferably an epoxide equivalent weight range from 182 to 192.

Thermally activatable or latent curing agents which can be employed for the epoxy resin in the case of the one-component systems are guanidines, substituted guanidines, substituted ureas, melamine resins, guanamine derivatives, cyclic tertiary amines, aromatic amines and/or mixtures thereof. In addition to or instead of the curing agents mentioned above, catalytically active substituted ureas can be employed.

The adhesives according to the invention can on the one hand be formulated as one-component adhesives, where these can be formulated both as highly viscous adhesives which can be applied warm, and also as thermally curable hot-melt adhesives. Furthermore, these adhesives can be formulated as one-component pre-gellable adhesives; in the latter case, the compositions comprise either finely divided thermoplastic powders, such as, for example, polymethacrylates, polyvinylbutyral or other thermoplastic (co)polymers, or the curing system is tuned in such a way that a two-step curing process takes place, where the gelling step causes only partial curing of the adhesive, and the final curing in vehicle building takes place, for example, in one of the painting ovens, preferably in the cathodic dip-coating oven.

The adhesive compositions according to the invention can also be formulated as two-component epoxy adhesives, in which the two reaction components are only mixed with one another just before application, where the curing then takes place at room temperature or moderately elevated temperature. The second reaction component employed here can be the reaction components which are known per se for two-component epoxy adhesives, for example di- or polyamines, amino-terminated polyalkylene glycols or polyaminoamides.

Furthermore, the adhesive compositions according to the invention may comprise further common assistants and additives, such as, for example, plasticisers, reactive thinners, rheology assistants, wetting agents, anti-ageing agents, stabilisers and/or coloured pigments.

The adhesive according to the invention usually comprises the matrix material in an amount of at least about 10% by weight. If the adhesive according to the invention is to be employed as hot-melt adhesive, it is advantageous for it to comprise at least one matrix material in a relatively large amount, for example at least about 50% by weight.

Likewise suitable as adhesives for the purposes of the present invention are hot-melt adhesives which contain post-crosslinking groups, as are usually employed for the production of particularly heat-resistant bonds. The use of polyurethanes as synthetic organic polymer is particularly suitable here.

The adhesive according to the invention may furthermore be a heat-seal adhesive. “Heat-seal adhesives comprising at least one organic polymer and core/shell particles” are taken to mean heat-activatable adhesives which are applied as solution, emulsion, dispersion or melt to the surface of the substrates to be sealed, where they initially set as a consequence of evaporation of the solvents or through cooling to give a non-tacky adhesive film. The subsequent bonding of the substrates generally takes place, after they have been joined and pressed together, by warming in hot presses or in a high-frequency field. On cooling, bonding of the workpieces takes place with solidification of the heat-seal adhesive layer comprising at least one organic polymer and core/shell particles. Particularly suitable for use in heat-seal adhesives comprising at least one organic polymer and core/shell particles are, for example, copolymers based on ethylene, (meth)acrylates, vinyl chloride, vinylidene chloride, vinyl acetate and polyamides, polyesters and polyurethanes.

The adhesive according to the invention may furthermore be a pressure-sensitive adhesive. Pressure-sensitive adhesives are generally viscoelastic adhesives which are permanently tacky and remain capable of adhesion in solvent-free form at 20° C. and immediately adhere to virtually all substrates with low substrate specificity under gentle pressure. Adhesive bonds produced using pressure-sensitive adhesives can usually be separated without destruction of the bonded substrates. For the purposes of the present invention, pressure-sensitive adhesives comprise, as organic synthetic polymer, for example natural and synthetic rubbers, polyacrylates, polyesters, polychloroprenes, polyisobutenes, polyvinyl ethers and polyurethanes. The pressure-sensitive adhesives may optionally also comprise additives, which favour, for example, one-sided re-detachability from paper surfaces.
In a further preferred embodiment of the invention, the adhesive according to the invention is a dispersion adhesive. “Dispersion adhesives” are mostly aqueous dispersions of organic polymers, which are suitable for bonding wood, paper, cardboard, wall coverings, leather, felt, cork, textiles, plastics or metals. Dispersion adhesives set by evaporation of the dispersion medium (water) with formation of an adhesive film. Suitable synthetic organic polymers in dispersion adhesives are, for example, polyacrylates, polymethacrylates, polyurethanes, polyesters, polyvinyl acetals, ethylene-vinyl acetate copolymers (EVA) and the like.

In addition to the said synthetic or natural organic polymers, the adhesive according to the invention may also comprise further additives, which influence, for example, the adhesive properties, the ageing behaviour, the setting process or the adhesion. Thus, the adhesive may comprise, for example, so-called tackifier resins, which can generally be divided into natural and synthetic (synthetic resins). These include, for example, alkyd resins, epoxy resins, melamine resins, phenolic resins, urethane resins, hydrocarbon resins and natural resins, such as colophony, wood turpentine and tall oil. The synthetic resins include hydrocarbon resins, ketone resins, coumarone-indene resins, isocyanate resins and terpene-phenolic resins. Furthermore, the adhesives according to the invention may comprise solvents. Suitable solvents are, for example, mono- or polyhydric alcohols having about 2 to about 10 C atoms.

Furthermore, the adhesives according to the invention may comprise antifoams. Suitable antifoams are, for example, antifoams based on fatty alcohol or based on silicone.
Furthermore, the adhesives may comprise protective colloids, such as polyvinylpyrrolidones, polyvinyl alcohols, cellulose or cellulose derivatives. Furthermore, the adhesive according to the invention may comprise stabilisers or antioxidants as additives. These generally include phenols, sterically hindered phenols of high molecular weight, polyfunctional phenols, sulfur- and phosphorus-containing phenols or amines. Suitable stabilisers are, for example, hydroquinone, hydroquinone methyl ether, 2,3-(di-tert-butyl)hydroquinone, 1,3,5-trimethyl-2,4,6-tris(3,5-di-tert-butyl-4-hydroxybenzyl)benzene, pentaerythritol tetrakis-3-(3,5-di-tert-butyl-4-hydroxyphenyl)propionate, n-octadecyl (3,5-di-tert-butyl-4-hydroxyphenyl)propionate, 4,4-methylenebis(2,6-di-tert-butylphenol), 4,4-thiobis(6-tert-butyl-o-cresol), 2,6-di-tert-butylphenol, 6-(4-hydroxyphenoxy)-2,4-bis(n-octylthio)-1,3,5-triazine, di-n-octadecyl 3,5-di-tert-butyl-4-hydroxybenzylphosphonate, 2-(n-octylthio)ethyl 3,5-di-tert-butyl-4-hydroxybenzoate, and sorbitol hexa-[3-(3,5-di-tert-butyl-4-hydroxyphenyl)propionate], and p-hydroxydiphenyl-amine or N,N′-diphenylenediamine or phenothiazine.

The adhesive according to the invention may furthermore comprise plasticisers, such as benzoate plasticisers, phosphate plasticisers, liquid resin derivatives or vegetable and animal oils. Suitable are, for example, sucrose benzoate, diethylene glycol dibenzoate and/or diethylene glycol benzoate in which about 50 to about 95% of all hydroxyl groups have been esterified, phosphate plasticisers, for example t-butylphenyl diphenyl phosphate, polyethylene glycols and derivatives thereof, for example diphenyl ethers of poly(ethylene glycol), liquid resin derivatives, for example the methyl esters of hydrogenated resin, vegetable and animal oils, for example glycerol esters of fatty acids and polymerisation products thereof.

Plasticisers based on phthalic acid, in particular alkyl phthalates. are likewise suitable.
The adhesive according to the invention may furthermore comprise colorants, such as titanium dioxide, fillers, such as talc, clay and the like, and pigments.
If the adhesive according to the invention is an adhesive which, for example, post-crosslinks through the influence of electron beams or UV rays, photoinitiators may furthermore be present in the adhesive as additives. For example, they can be Norrish type I fragmenting substances, such as benzophenone, hydroquinone, photoinitiators from the Irgacure®, Darocure® or Speedcure® series (manufacturer: Ciba-Geigy). The adhesive according to the invention may optionally comprise a monofunctional reactive thinner, which can be polymerised, for example, by irradiation with UV light or with electron beams. Suitable for this purpose are, in particular, the corresponding esters of acrylic acid or methacrylic acid. Examples of such esters are, inter alia, n-butyl acrylate, 2-ethylhexyl acrylate, 3-methoxybutyl acrylate, 2-phenoxyethyl acrylate, benzyl acrylate or 2-methoxypropyl acrylate.
Furthermore, the adhesives according to the invention may comprise emulsifiers or stabilisers or a mixture thereof. Suitable emulsifiers are generally surfactants which contain a hydrophilic group and a hydrophobic group. They may be anionic emulsifiers, cationic emulsifiers or amphoteric emulsifiers. For example, hydrocarbon emulsifiers having about 6 to about 22 carbon atoms, where the hydrocarbon chain may be branched, unbranched, saturated, unsaturated, substituted, aliphatic or aromatic, are suitable. During preparation of the adhesives according to the invention, the synthetic organic polymer or the natural organic polymer or the mixture of one or more synthetic organic polymers and one or more natural organic polymers is mixed with the core/shell particles and optionally with a solvent and further additives. If the adhesive according to the invention is intended to be a hot-melt adhesive, the mixing can be carried out in the melt of the hot-melt adhesive, but it is likewise possible to add the core/shell particles as early as during preparation of the polymer employed as hot-melt adhesive. If the adhesive according to the invention is intended to be a dispersion adhesive, the core/shell particles can be incorporated directly into the polymer dispersion of the dispersion adhesive.
In a further preferred embodiment of the invention, the core/shell particles in a dispersion adhesive according to the invention are already added before the preparation of the synthetic organic polymer. The dispersion adhesive according to the invention is prepared here by emulsion polymerisation, in which droplets of monomers which are necessary for preparation of the later polymer are usually polymerised in an aqueous emulsion. The core/shell particles can be added to the emulsion even before the polymerisation, which results in a particularly homogeneous distribution of the core/shell particles in the dispersion adhesive.
The invention therefore furthermore relates to a process for the preparation of an adhesive, characterised in that a polymer, core/shell particles and optionally solvents or further additives are mixed.
The present invention likewise relates to the use of core/shell particles in adhesives or as additive to adhesives.

The polymer/oligomer chains of the shell can be produced as described in PCT/EP 2008/000532. This may be polymerisation away from a core element, or the reaction of correspondingly reactively modified polymer/oligomer chains with a core. Suitable for this purpose are preferably polymer/oligomer chains which have been terminally modified at one end or also polymer/oligomer chains which contain only one group which is reactive with the core material. Furthermore, it is possible to produce the cores from correspondingly modified oligomers/polymers by a suitable reaction (for example hydrolysis/polycondensation). Suitable for this purpose are preferably hydrolysable silicon compounds which are terminally covalently bonded, such as, for example trimethoxyorganosilanes.

The particles produced in this way have a very advantageous, star-like structure. The star-like structure produces a very positive viscosity behaviour of the nanohybrid adhesive. Since the polymer chains are held together by a central linking point, the formation of large, freely unfolded polymer chains, as occurs in a conventional polymer solution, is suppressed. It is thus possible to produce polymer coils of very high molecular weight, which, in solution, have lower viscosity compared with conventional polymers of the same molecular weight.

Particles according to the invention have cores having a diameter in the range from 1 nm to 1 μm, where the cores may comprise inorganic or organic constituents or a mixture of inorganic or organic constituents. The cores are preferably inorganic.

The diameters can be determined by means of a Malvern ZETASIZER (particle correlation spectroscopy, PCS) or transmission electron microscope.

Particular preference is given to substantially round cores having a diameter of 1 to 25 nm, in particular 1 to 10 nm. Substantially round in the sense of the present invention includes ellipsoidal and irregularly shaped cores. In specific, likewise preferred embodiments of the present invention, the distribution of the particle sizes is narrow, i.e. the variation latitude is less than 100% of the average, particularly preferably a maximum of 50% of the average.

Preference is furthermore given to flake-form particles having a thickness in the range 1-500 nm, as are known, for example, in the form of natural or synthetic phyllosilicates.

Suitable cores can be nanoparticles produced separately or in a prior step, as are well known to the person skilled in the art, such as, for example: SiO₂, ZrO₂, TiO₂, CeO₂, ZnO, etc., but also 3-dimensionally crosslinked organosesquisiloxane structures and metal oxides/hydroxides, in particular silsesquioxane structures (for example known under the trade name POSS™ from Hybrid Plastics), or heteropolysiloxanes, in particular cubic or other 3-dimensional representatives of this class of materials. Hybrids of nanoparticles and silsesquioxane structures can likewise be employed as cores. It is furthermore in principle possible to employ cores based on phyllosilicates, sulfates, silicates, carbonates, nitrides, phosphates, sulfides of corresponding size. A further suitable core material is selected from organic polymers/oligomers, in particular organic nanoparticles, for example consisting of free-radical-polymerised monomers. Dendrimers or hyper-branched polymers can in principle likewise serve as core material.

The core may in addition also be built up in situ from suitable polymer chains. Preferably suitable for this purpose are terminally reactively modified polymers, which form the core or substantial parts of the core in a linking step. Suitable for this purpose are, in particular, alkoxysilane-modified polymer chains, particularly preferably trialkoxysilane-modified polymer chains. The core formation in the case of these polymers preferably takes place under reaction conditions which are suitable for the formation of spherical structures. The silane modification is carried out, in particular, under basic reaction conditions, comparable with the Stöber synthesis, which is known to the person skilled in the art. Besides alkoxysilanes, it is of course also possible to employ other suitable metal compounds, for example of Ti, Zr, Al, and to react them under conditions which are optimum for the respective species. The reaction can also be carried out in the presence of a pre-formed template (nucleus, core/shell particles, etc.) or other reaction partners (silanes, metal alkoxides, salts) in order to achieve the aim according to the invention.

Preferred cores are selected from the group consisting of hydrophilic and hydrophobic, in particular hydrophilic, cores based on sulfates or carbonates of alkaline-earth metal compounds or on oxides or hydroxides of silicon, titanium, zinc, aluminium, cerium, cobalt, chromium, nickel, iron, yttrium or zirconium or mixtures thereof, which may optionally be coated with metal oxides or hydroxides, for example of silicon, zirconium, titanium or aluminium, or metals, such as, for example, Ag, Cu, Fe, Au, Pd, Pt or alloys, coated with metal oxides or hydroxides, for example of silicon, zirconium, titanium or aluminium. The individual oxides may also be in the form of mixtures. The metal of the metal oxide or hydroxide is preferably silicon. The cores are particularly preferably selected from SiO₂ particles or they are selected from ZnO or cerium oxide particles or TiO₂ particles, which may optionally be coated with metal oxides or hydroxides, for example of silicon, zirconium, titanium or aluminium.

In the case of ZnO or cerium oxide particles as cores, the adhesives according to the invention can be employed as UV-absorbent adhesives owing to the absorption properties of zinc oxide or cerium oxide. Suitable zinc oxide particles having a particle size of 3 to 50 nm are obtainable, for example, by a process in which, in a step a), one or more precursors of the ZnO ncore/shell particles are converted into the core/shell particles in an organic solvent, and, in a step b), the growth of the core/shell particles is terminated by addition of at least one modifier, the precursor of silica, when the absorption edge in the UV/VIS spectrum of the reaction solution has reached the desired value. The process and the suitable modifiers and process parameters are described in DE 10 2005 056622.7.

Alternatively, suitable zinc oxide particles can be produced by a process in which, in a step a), one or more precursors of the ZnO core/shell particles are converted into the core/shell particles in an organic solvent, and, in a step b), the growth of the core/shell particles is terminated by addition of at least one copolymer comprising at least one monomer containing hydrophobic radicals and at least one monomer containing hydrophilic radicals when the absorption edge in the UV/VIS spectrum of the reaction solution has reached the desired value. This process and the suitable copolymers, monomers and process parameters are described in DE 10 2005 056621.

It is also possible to use nanohectorites, which are marketed, for example, by Südchemie under the Optigel® brand or by Laporte under the Laponite® brand. Very particular preference is also given to silica sols (SiO₂ in water), prepared from ion-exchanged water-glass (for example Levasile® from H.C. Starck) or dispersions of particles deposited from the gas phase, such as, for example: Aerosil® from Degussa or Nanopure® from SDC or filter dusts from aluminium or silicon manufacture, such as, for example, the SiO₂ products marketed by Elkem under the name “Sidastar”.

If the core does not already have high reactivity and the possibility of the formation of covalent bonds to the oligomers/polymers, it is advantageous to apply an adhesion promoter or another suitable surface modification. Accordingly, in a further embodiment of the present invention, the surface of the cores has been modified by means of at least one surface modifier. These are, for example, organofunctional silanes, organometallic compounds, such as, for example, zirconium tetra-n-propoxide, or mixtures or polyfunctional organic molecules which have optimised reactivity towards the core material and the oligomers/polymers to be connected thereto. The surface modification is preferably chemical, i.e. the bonding takes place via hydrogen bonds, electrostatic interactions, chelate bonds or via covalent bonds. The surface modifier is preferably covalently bonded to the surface of the core. The at least one surface modifier is preferably selected from the group consisting of organofunctional silanes, quaternary ammonium compounds, carboxylic acids, phosphonates, phosphonium and sulfonium compounds and mixtures thereof. At least one surface modifier particularly preferably contains at least one functional group selected from the group consisting of thiols, sulfides, disulfides and polysulfides.

Common processes for the production of surface-modified core/shell particles start from aqueous particle dispersions, to which the surface modifier is added. However, the reaction with the surface modifiers can also be carried out in an organic solvent or in solvent mixtures. This applies, in particular, to ZnO core/shell particles. Preferred solvents are alcohols or ethers, where the use of methanol, ethanol, diethyl ether, tetrahydrofuran and/or dioxane or mixtures thereof is particularly preferred. Methanol has proven to be a particularly suitable solvent. If desired, assistants, such as, for example, surfactants or protective colloids (for example hydroxypropylcellulose), may also be present during the reaction. The surface modifiers can be employed alone, as mixtures or mixed with further, optionally non-functional surface modifiers. The surface modifier requirements described are satisfied, in particular, in accordance with the invention by an adhesion promoter which carries two or more functional groups. One group of the adhesion promoter reacts chemically with the oxide surface of the core/shell particle. Particularly suitable here are alkoxysilyl groups (for example methoxy- and ethoxysilanes), halosilanes (for example chlorosilanes) or acidic groups of phosphoric acid esters or phosphonic acids and phosphonic acid esters or carboxylic acids. The groups described are linked to a second functional group via a more or less long spacer. This spacer comprises non-reactive alkyl chains, siloxanes, polyethers, thioethers or urethanes or combinations of these groups of the general formula (C,Si)ₙHₘ(N,O,S)ₓ, where n=1-50, m=2-100 and x=0-50. The functional group is preferably a thiol, sulfide, polysulfide, in particular tetrasulfide, or disulfide group. Besides the thiol, sulfide, polysulfide or disulfide groups, the adhesion promoter described above may contain further functional groups. The additional functional groups are, in particular, acrylate, methacrylate, vinyl, amino, cyano, isocyanate, epoxide, carboxyl or hydroxyl groups.

Silane-based surface modifiers are described, for example, in DE 40 11 044 C2. Surface modifiers based on phosphoric acid are obtainable, inter alia, as Lubrizol® 2061 and 2063 from LUBRIZOL (Langer & Co.). A suitable silane is, for example, mercaptopropyltrimethoxysilane. This and other silanes are commercially available, for example from ABCR GmbH & Co., Karlsruhe, or Degussa, Germany, under the trade name Dynasilan. Mercaptophosphonic acid or diethyl mercaptophosphonate may also be mentioned here as adhesion promoter.

Alternatively, the surface modifier can be an amphiphilic silane of the general formula (R)₃Si—S_{P}-Aₕₚ-B_{hb}, where the radicals R may be identical or different and represent hydrolytically removable radicals, S_{P} denotes either —O- or straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms, Aₕₚ denotes a hydrophilic block, B_{hb} denotes a hydrophobic block, and where at least one thiol, sulfide or disulfide group on Aₕₚ and/or B_{hb} is in bonded form. The use of amphiphilic silanes gives rise to core/shell particles which can be redispersed particularly well, both in polar and in nonpolar solvents.

The amphiphilic silanes contain a head group (R)₃Si, where the radicals R may be identical or different and represent hydrolytically removable radicals. The radicals R are preferably identical.

Suitable hydrolytically removable radicals are, for example, alkoxy groups having 1 to 10 C atoms, preferably having 1 to 6 C atoms, halogens, hydrogen, acyloxy groups having 2 to 10 C atoms and in particular having 2 to 6 C atoms or NR′₂ groups, where the radicals R′ may be identical or different and are selected from hydrogen and alkyl having 1 to 10 C atoms, in particular having 1 to 6 C atoms. Suitable alkoxy groups are, for example, methoxy, ethoxy, propoxy or butoxy groups. Suitable halogens are, in particular, Br and Cl. Examples of acyloxy groups are acetoxy and propoxy groups. Oximes are furthermore also suitable as hydrolytically removable radicals. The oximes here may be substituted by hydrogen or any desired organic radicals. The radicals R are preferably alkoxy groups and in particular methoxy or ethoxy groups.

A spacer S_{P} is covalently bonded to the above-mentioned head group and functions as connecting element between the Si head group and the hydrophilic block Aₕₚ and takes on a bridge function for the purposes of the present invention. The group S_{P} is either —O- or straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms.

The C₁-C₁₈-alkyl group of S_{P} is, for example, a methyl, ethyl, isopropyl, propyl, butyl, sec-butyl or tert-butyl, furthermore also pentyl, 1-, 2- or 3-methylbutyl, 1,1-, 1,2- or 2,2-dimethylpropyl, 1-ethylpropyl, hexyl, heptyl, octyl, nonyl, decyl, undecyl, dodecyl, tridecyl or tetradecyl group. It may optionally be perfluorinated, for example as difluoromethyl, tetrafluoroethyl, hexafluoropropyl or octafluorobutyl group.

A straight-chain or branched alkenyl having 2 to 18 C atoms, in which a plurality of double bonds may also be present, is, for example, vinyl, allyl, 2- or 3-butenyl, isobutenyl, sec-butenyl, furthermore 4-pentenyl, isopentenyl, hexenyl, heptenyl, octenyl, —C₉H₁₆, —C₁₀H₁₈ to —C₁₈H₃₄, preferably allyl, 2- or 3-butenyl, isobutenyl, sec-butenyl, furthermore preferably 4-pentenyl, isopentenyl or hexenyl.

A straight-chain or branched alkynyl having 2 to 18 C atoms, in which a plurality of triple bonds may also be present, is, for example, ethynyl, 1- or 2-propynyl, 2- or 3-butynyl, furthermore 4-pentynyl, 3-pentynyl, hexynyl, heptynyl, octynyl, —C₉H₁₄, —C₁₀H₁₆ to —C₁₈H₃₂, preferably ethynyl, 1- or 2-propynyl, 2- or 3-butynyl, 4-pentynyl, 3-pentynyl or hexynyl.

Unsubstituted saturated or partially or fully unsaturated cycloalkyl groups having 3-7 C atoms can be cyclopropyl, cyclobutyl, cyclopentyl, cyclohexyl, cycloheptyl, cyclopentenyl, cyclopenta-1,3-dienyl, cyclohexenyl, cyclohexa-1,3-dienyl, cyclohexa-1,4-dienyl, phenyl, cycloheptenyl, cyclohepta-1,3-dienyl, cyclohepta-1,4-dienyl or cyclohepta-1,5-dienyl groups, which are substituted by C₁- to C₆-alkyl groups.

The spacer group S_{P} is connected to the hydrophilic block Aₕₚ. The latter can be selected from nonionic, cationic, anionic and zwitterionic hydrophilic polymers, oligomers and groups. In the simplest embodiment, the hydrophilic block comprises ammonium, sulfonium or phosphonium groups, alkyl chains containing carboxyl, sulfate or phosphate side groups, which may also be in the form of a corresponding salt, partially esterified anhydrides containing a free acid or salt group, OH-substituted alkyl or cycloalkyl chains (for example sugars) containing at least one OH group, NH- and SH-substituted alkyl or cycloalkyl chains or mono-, di-, tri- or oligoethylene glycol groups. The length of the corresponding alkyl chains can be 1 to 20 C atoms, preferably 1 to 6 C atoms.

The nonionic, cationic, anionic or zwitterionic hydrophilic polymers, oligomers or groups here can be prepared from corresponding monomers by polymerisation by the methods which are generally known to the person skilled in the art. Suitable hydrophilic monomers here contain at least one dispersing functional group selected from the group consisting of

(i) functional groups which can be converted into anions by neutralisers, and anionic groups, and/or
(ii) functional groups which can be converted into cations by neutralisers and/or quaternising agents, and cationic groups, and/or
(iii) nonionic hydrophilic groups.

The functional groups (i) are preferably selected from the group consisting of carboxyl, sulfonyl and phosphonyl groups, acidic sulfuric acid and phosphoric acid ester groups and carboxylate, sulfonate, phosphonate, sulfate ester and phosphate ester groups, the functional groups (ii) are preferably selected from the group consisting of primary, secondary and tertiary amino groups, primary, secondary, tertiary and quaternary ammonium groups, quaternary phosphonium groups and tertiary sulfonium groups, and the functional groups (iii) are preferably selected from the group consisting of omega-hydroxy- and omega-alkoxypoly(alkylene oxide)-1-yl groups.

If not neutralised, the primary and secondary amino groups can also serve as isocyanate-reactive functional groups.

Examples of highly suitable hydrophilic monomers containing functional groups (i) are acrylic acid, methacrylic acid, beta-carboxyethyl acrylate, ethacrylic acid, crotonic acid, maleic acid, fumaric acid and itaconic acid; olefinically unsaturated sulfonic and phosphonic acids and partial esters thereof; and mono(meth)acryloyloxyethyl maleate, mono(meth)acryloyloxyethyl succinate and mono(meth)acryloyloxyethyl phthalate, in particular acrylic acid and methacrylic acid.

Examples of highly suitable hydrophilic monomers containing functional groups (ii) are 2-aminoethyl acrylate and methacrylate and allylamine.

Examples of highly suitable hydrophilic monomers containing functional groups (iii) are omega-hydroxy- and omega-methoxypoly(ethylene oxide)-1-yl, omega-methoxypoly(propylene oxide)-1-yl and omega-methoxypoly-(ethylene oxide-co-polypropylene oxide)-1-yl acrylate and methacrylate, and hydroxyl-substituted ethylenes, acrylates and methacrylates, such as, for example, hydroxyethyl methacrylate.

Examples of suitable monomers for the formation of zwitterionic hydrophilic polymers are those in which a betaine structure occurs in the side chain. The side group is preferably selected from —(CH₂)ₘ—(N⁺(CH₃)₂)—(CH₂)ₙ—SO₃⁻, —(CH₂)ₘ—(N⁺(CH₃)₂)—(CH₂)ₙ—PO₃²⁻, —(CH₂)ₘ—(N⁺(CH₃)₂)—(CH₂)ₙ—O—PO₃²⁻ and —(CH₂)ₘ—(P⁺(CH₃)₂)—(CH₂)ₙ—SO₃⁻, where m stands for an integer from the range 1 to 30, preferably from the range 1 to 6, particularly preferably 2, and n stands for an integer from the range 1 to 30, preferably from the range 1 to 8, particularly preferably 3.

It may be particularly preferred here for at least one structural unit of the hydrophilic block to contain a phosphonium or sulfonium radical.

When selecting the hydrophilic monomers, it should be ensured that the hydrophilic monomers containing functional groups (i) and the hydrophilic monomers containing functional groups (ii) are preferably combined with one another in such a way that no insoluble salts or complexes are formed. By contrast, the hydrophilic monomers containing functional groups (i) or containing functional groups (ii) can be combined as desired with the hydrophilic monomers containing functional groups (iii).

Of the hydrophilic monomers described above, the monomers containing functional groups (i) are particularly preferably used.

The neutralisers for the functional groups (i) which can be converted into anions are preferably selected here from the group consisting of ammonia, trimethylamine, triethylamine, tributylamine, dimethylaniline, diethylaniline, triphenylamine, dimethylethanolamine, diethylethanolamine, methyldiethanolamine, 2-aminomethylpropanol, dimethylisopropylamine, dimethylisopropanolamine, triethanolamine, diethylenetriamine and triethylenetetramine, and the neutralisers for the functional groups (ii) which can be converted into cations are preferably selected from the group consisting of sulfuric acid, hydrochloric acid, phosphoric acid, formic acid, acetic acid, lactic acid, dimethylolpropionic acid and citric acid.

The hydrophilic block is very particularly preferably selected from mono-, di- and triethylene glycol structural units.

The hydrophobic block B_{hb} follows bonded to the hydrophilic block Aₕₚ. The block B_{hb} is based on hydrophobic groups or, like the hydrophilic block, on hydrophobic monomers which are suitable for polymerisation.

Examples of suitable hydrophobic groups are straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms. Examples of such groups have already been mentioned above. In addition, aryl, polyaryl, aryl-C₁-C₆-alkyl or esters having more than 2 C atoms are suitable. The said groups may, in addition, also be substituted, in particular by halogens, where perfluorinated groups are particularly suitable.

Aryl-C₁-C₆-alkyl denotes, for example, benzyl, phenylethyl, phenylpropyl, phenylbutyl, phenylpentyl or phenylhexyl, where both the phenyl ring and also the alkylene chain may be partially or fully substituted by F as described above, particularly preferably benzyl or phenylpropyl.

Examples of suitable hydrophobic olefinically unsaturated monomers for the hydrophobic block B_{hb} are

(1) esters of olefinically unsaturated acids which are essentially free from acid groups, such as alkyl or cycloalkyl esters of (meth)acrylic acid, crotonic acid, ethacrylic acid, vinylphosphonic acid or vinylsulfonic acid having up to 20 carbon atoms in the alkyl radical, in particular methyl, ethyl, propyl, n-butyl, sec-butyl, tert-butyl, hexyl, ethylhexyl, stearyl or lauryl acrylate, methacrylate, crotonate, ethacrylate or vinylphosphonate or vinylsulfonate; cycloaliphatic esters of (meth)acrylic acid, crotonic acid, ethacrylic acid, vinylphosphonic acid or vinylsulfonic acid, in particular cyclohexyl, isobornyl, dicyclopentadienyl, octahydro-4,7-methano-1H-indenemethanol or tert-butylcyclohexyl (meth)acrylate, crotonate, ethacrylate, vinylphosphonate or vinylsulfonate. These may comprise minor amounts of polyfunctional alkyl or cycloalkyl esters of (meth)acrylic acid, crotonic acid or ethacrylic acid, such as ethylene glycol, propylene glycol, diethylene glycol, dipropylene glycol, butylene glycol, pentane-1,5-diol, hexane-1,6-diol, octahydro-4,7-methano-1H-indenedimethanol or cyclohexane-1,2-, -1,3- or -1,4-diol di(meth)acrylate, trimethylolpropane tri(meth)acrylate or pentaerythritol tetra(meth)acrylate, and the analogous ethacrylates or crotonates. For the purposes of the present invention, minor amounts of polyfunctional monomers (1) are taken to mean amounts which do not result in crosslinking or gelling of the polymers;

(2) monomers which carry at least one hydroxyl group or hydroxymethylamino group per molecule and are essentially free from acid groups, such as
hydroxyalkyl esters of alpha,beta-olefinically unsaturated carboxylic acids, such as hydroxyalkyl esters of acrylic acid, methacrylic acid and ethacrylic acid, in which the hydroxyalkyl group contains up to 20 carbon atoms, such as 2-hydroxyethyl, 2-hydroxypropyl, 3-hydroxypropyl, 3-hydroxybutyl, 4-hydroxybutyl acrylate, methacrylate or ethacrylate; 1,4-bis(hydroxymethyl)cyclohexane, octahydro-4,7-methano-1H-indenedimethanol or methylpropanediol monoacrylate, monomethacrylate, monoethacrylate or monocrotonate; or products of the reaction of cyclic esters, such as, for example, epsilon-caprolactone, and these hydroxyalkyl esters;
olefinically unsaturated alcohols, such as allyl alcohol;
allyl ethers of polyols, such as trimethylolpropane monoallyl ether or pentaerythritol mono-, -i- or triallyl ether. The polyfunctional monomers are generally only used in minor amounts. For the purposes of the present invention, minor amounts of polyfunctional monomers are taken to mean amounts which do not result in crosslinking or gelling of the polymers;
products of the reaction of alpha,beta-olefinically unsaturated carboxylic acids with glycidyl esters of an alpha-branched monocarboxylic acid having 5 to 18 carbon atoms in the molecule. The reaction of acrylic or methacrylic acid with the glycidyl ester of a carboxylic acid containing a tertiary alpha-carbon atom can take place before, during or after the polymerisation reaction. The monomer (2) employed is preferably the product of the reaction of acrylic and/or methacrylic acid with the glycidyl ester of Versatic® acid. This glycidyl ester is commercially available under the name Cardura® E10. Reference is additionally made to Römpp Lexikon Lacke and Druckfarben [Römpp's Lexicon of Surface Coatings and Printing Inks], Georg Thieme Verlag, Stuttgart, New York, 1998, pages 605 and 606;
formaldehyde adducts of aminoalkyl esters of alpha,beta-olefinically un-saturated carboxylic acids and of alpha,beta-unsaturated carboxamides, such as N-methylol- and N,N-dimethylolaminoethyl acrylate, -aminoethyl methacrylate, -acrylamide and -methacrylamide; and
olefinically unsaturated monomers containing acryloxysilane groups and hydroxyl groups, which can be prepared by reaction of hydroxyl-functional silanes with epichlorohydrin 30 and subsequent reaction of the intermediate with an alpha,beta-olefinically unsaturated carboxylic acid, in particular acrylic acid and methacrylic acid, or hydroxyalkyl esters thereof;

(3) vinyl esters of alpha-branched monocarboxylic acids having 5 to 18 carbon atoms in the molecule, such as the vinyl esters of Versatic® acid, which are marketed under the VeoVa® brand;

(4) cyclic and/or acyclic olefins, such as ethylene, propylene, but-1-ene, pent-1-ene, hex-1-ene, cyclohexene, cyclopentene, norbornene, butadiene, isoprene, cyclopentadiene and/or dicyclopentadiene;

(5) amides of alpha,beta-olefinically unsaturated carboxylic acids, such as (meth)acrylamide, N-methyl-, N,N-dimethyl-, N-ethyl-, N,N-diethyl-, N-propyl-, N,N-dipropyl-, N-butyl-, N,N-dibutyl- and/or N,N-cyclohexylmethyl-(meth)acrylamide;

(6) monomers containing epoxide groups, such as the glycidyl esters of acrylic acid, methacrylic acid, ethacrylic acid, crotonic acid, maleic acid, fumaric acid and/or itaconic acid;

(7) vinylaromatic hydrocarbons, such as styrene, vinyltoluene or alpha-alkylstyrenes, in particular alpha-methylstyrene;

(8) nitriles, such as acrylonitrile or methacrylonitrile;

(9) vinyl compounds, selected from the group consisting of vinyl halides, such as vinyl chloride, vinyl fluoride, vinylidene dichloride, vinylidene difluoride; vinylamides, such as N-vinylpyrrolidone; vinyl ethers, such as ethyl vinyl ether, n-propyl vinyl ether, isopropyl vinyl ether, n-butyl vinyl ether, isobutyl vinyl ether and vinyl cyclohexyl ether; and vinyl esters, such as vinyl acetate, vinyl propionate and vinyl butyrate;

(10) allyl compounds, selected from the group consisting of allyl ethers and esters, such as propyl allyl ether, butyl allyl ether, ethylene glycol diallyl ether, trimethylolpropane triallyl ether or allyl acetate or allyl propionate; as far as the polyfunctional monomers are concerned, that stated above applies analogously;

(11) siloxane or polysiloxane monomers, which may be substituted by saturated, unsaturated, straight-chain or branched alkyl groups or other hydrophobic groups already mentioned above. Also suitable are polysiloxane macromonomers which have a number average molecular weight Mn of 1000 to 40.000 and contain on average 0.5 to 2.5 ethylenically unsaturated double bonds per molecule, in particular polysiloxane macromonomers which have a number average molecular weight Mn of 2000 to 20.000, particularly preferably 2500 to 10.000 and in particular 3000 to 7000, and contain on average 0.5 to 2.5, preferably 0.5 to 1.5, ethylenically unsaturated double bonds per molecule, as described in DE 38 07 571 A 1 on pages 5 to 7, DE 37 06 095 A 1 in columns 3 to 7, EP 0 358 153 B 1 on pages 3 to 6, in U.S. Pat. No. 4,754,014 A 1 in columns 5 to 9, in DE 44 21 823 A 1 or in International Patent Application WO 92/22615 on page 12, line 18, to page 18, line 10; and (12) monomers containing carbamate or allophanate groups, such as acryloyloxy- or methacryloyloxyethyl, -propyl or -butyl carbamate or allophanate; further examples of suitable monomers which contain carbamate groups are described in the patent specifications U.S. Pat. No. 3,479,328 A 1, U.S. Pat. No. 3,674,838 A 1, U.S. Pat. No. 4,126,747 A 1, U.S. Pat. No. 4,279,833 A 1 or U.S. Pat. No. 4,340,497 A 1.

The polymerisation of the above-mentioned monomers can be carried out in any way known to the person skilled in the art, for example by polyadditions or cationic, anionic or free-radical polymerisations. Polyadditions are preferred in this connection since different types of monomer can thus be combined with one another in a simple manner, such as, for example, epoxides with dicarboxylic acids or isocyanates with diols.

The respective hydrophilic and hydrophobic blocks can in principle be combined with one another in any desired manner. The amphiphilic silanes in accordance with the present invention preferably have an HLB value in the range 2-19, preferably in the range 4-15. The HLB value is defined here as

$$HLB = \frac{mass of polar fractions}{molecular weight} \cdot 20$$

and indicates whether the silane has more hydrophilic or hydrophobic behaviour, i.e. which of the two blocks Aₕₚ and B_{hb} dominates the properties of the silane according to the invention. The HLB value is calculated theoretically and arises from the mass fractions of hydrophilic and hydrophobic groups. An HLB value of 0 indicates a lipophilic compound, a chemical compound having an HLB value of 20 has only hydrophilic fractions.

The suitable amphiphilic silanes are furthermore distinguished by the fact that at least one thiol, sulfide or disulfide group is advantageously bonded to Aₕₚ and/or B_{hb}. The reactive functional group is preferably located on the hydrophobic block B_{hb}, where it is particularly preferably bonded at the end of the hydrophobic block. In the preferred embodiment, the head group (R)₃Si and the thiol, sulfide or disulfide group have the greatest possible separation. This enables particularly flexible setting of the chain lengths of blocks Aₕₚ and B_{hb} without significantly restricting the possible reactivity of the thiol, sulfide or disulfide group, for example with the ambient medium.

In addition, besides the thiol, sulfide, polysulfide or disulfide group, further reactive functional groups may be present, in particular selected from silyl groups containing hydrolytically removable radicals, OH, carboxyl, NH and SH groups, halogens or reactive groups containing double bonds, such as, for example, acrylate or vinyl groups. Suitable silyl groups containing hydrolytically removable radicals have already been described above in the description of the head group (R)₃Si. The additional reactive group is preferably an OH group.

In the particles according to the invention, oligomers and/or polymers are preferably bonded radially to the cores. The polymer or oligomer chains can be brought to reaction with the core material by all processes known to the person skilled in the art in order preferably to form at least one covalent bond.

The present invention thus furthermore relates to a process for the preparation of the adhesive according to the invention, comprising the dispersal of cores having a diameter of >1 nm in a solvent or solvent mixture and polymerisation in the presence of organic monomers, where the oligomers and/or polymers formed are preferably radially bonded to the cores. It is desirable here that the oligomer/polymer only reacts with the core material by means of one reaction centre per polymer/oligomer chain, and it is particularly preferred that this reaction centre is positioned terminally on the polymer chain. Use can be made here of both polymers/oligomers formed in a prior step or in an external reaction, and also polymers/oligomers formed in situ during the covalent bonding to the core material. This may be the case, for example, during a free-radical polymerisation with unsaturated monomers in the presence of the core material, which has preferably been correspondingly (SH) surface-modified. Owing to the steric hindrance of the polymers/oligomers with one another, it may generally be advantageous for the polymers to be formed starting from the core material and not subsequently bonded to the core. The polymerisation away from the core thus enables, if desired, substantially complete and dense coverage of the core material with polymer to be ensured. The formation of the polymer chain can take place via various chain-growth reactions known to the person skilled in the art. Mention may be made here by way of example of ionic polymerisations (starting from epoxide functions or halogenated aromatic compounds) and free-radical polymerisations, where the latter are preferred since they can also be carried out in aqueous environments.

The synthesis of the polymers and/or oligomers can be carried out by chain-growth reactions known to the person skilled in the art, where the chains are initiated or terminated by means of a reactive group which is able to react with the particle surface. Mention may be made here by way of example of anionic polymerisation and controlled and free-radical polymerisation, in particular RAFT, ATRP or SET-LRP.

In a further preferred case, the core material is formed during the covalent linking of the polymer/oligomer chains. To this end, use is preferably made of polymers/oligomers which have been terminally modified by means of hydrolysable/condensable organosilane or organometallic compounds and which are reacted in a hydrolysis and polymerisation (also in the presence of further organosilicon and organometallic compounds) to give a core material. Typical oligomers/polymers according to the invention are, for example: trialkoxysilylmercaptopropyl-terminated polyacrylates, which are obtainable, for example, by free-radical polymerisation of one or more unsaturated compounds with mercaptopropyltrialkoxysilane as chain-transfer agent or bis[3-trimethoxysilylpropyl] disulfide as initiator. Preference is furthermore also given to the use of the products of the reaction of terminally OH-modified polyesters or polyethers with isocyanatoalkyltrialkoxysilane. Alternatively, it is also possible to employ polymers containing a hydrolysable silyl compound in the polymer chain, which then achieves linking of two oligomer/polymer strands via a connecting element. Oligomers/polymers of this type are obtainable, for example, by free-radical polymerisation of unsaturated compounds in the presence of methacryloxypropyltrimethoxysilane.

Besides organosilyl and organometallic reaction centres, it is also possible to employ suitable organic reaction centres, such as, for example, amine, epoxide, hydroxyl, mercapto, isocyanate, carboxylate, allyl or vinyl groups, for reaction with suitable reactants on the core material side. For example, an epoxide-functional core material is able to react with an amino-functional polymer or an amine-modified core material is able to react with an isocyanate-functional polymer/oligomer.

The polymers/oligomers can be composed of all known polymeric substance groups, or mixtures thereof. In particular, the oligomers and/or polymers are selected from the group consisting of poly(meth)acrylates, polyesters, polyurethanes, polyureas, silicones, polyethers, polyamides, polyimides and mixtures and hybrids thereof.

Examples of highly suitable monomers for the formation of corresponding oligomers and/or polymers containing functional groups are acrylic acid, methacrylic acid, beta-carboxyethyl acrylate, ethacrylic acid, crotonic acid, maleic acid, fumaric acid and itaconic acid; olefinically unsaturated sulfonic or phosphonic acids and partial esters thereof; and mono(meth)acryloyloxyethyl maleate, mono(meth)acryloyloxyethyl succinate and mono(meth)acryloyloxyethyl phthalate, in particular acrylic acid and methacrylic acid. Further examples of highly suitable monomers containing functional groups are 2-aminoethyl acrylate and methacrylate and allylamine.

Further suitable monomers containing functional groups are omega-hydroxy- and omega-methoxypoly(ethylene oxide)-1-yl, omega-methoxypoly(propylene oxide)-1-yl and omega-methoxypoly(ethylene oxide-copolypropylene oxide)-1-yl acrylate and methacrylate, and hydroxyl-substituted ethylenes, acrylates and methacrylates, such as, for example, hydroxyethyl methacrylate and hydroxypropyl methacrylate.

Examples of suitable monomers for the formation of zwitterionic hydrophilic polymers are those in which a betaine structure occurs in the side chain. The side group is preferably selected from —(CH₂)ₘ—(N⁺(CH₃)₂)—(CH₂)ₙ—SO₃⁻, —(CH₂)ₘ—(N⁺(CH₃)₂)—(CH₂)ₙ—PO₃²⁻, —(CH₂)ₘ—(N⁺(CH₃)₂)—(CH₂)ₙ—O—PO₃²⁻ and —(CH₂)ₘ—(P⁺(CH₃)₂)—(CH₂)ₙ—SO₃⁻, where m stands for an integer from the range 1 to 30, preferably from the range 1 to 6, particularly preferably 2, and n stands for an integer from the range 1 to 30, preferably from the range 1 to 8, particularly preferably 3.

At least three and particularly preferably at least six polymer/oligomer chains are covalently bonded per core. The maximum number of polymer/oligomer chains bonded to a core is limited only by the technical feasibility and preparation ability.

The polymers consist of a monomer or (preferably) of monomer mixtures. The monomers can preferably also carry reactive groups in the side chains, such as, for example, hydroxyl, epoxide, allyl, blocked isocyanate, etc. Furthermore, the side chains may additionally have a functional structure: for example hydroxybenzophenone, benzotriazole as UV absorber or fluorescent dyes, which are incorporated into the polymer chain via acrylate function.

The polymer/oligomer sheath is preferably reactive towards further components of the surface coatings, such as, for example, crosslinking agents (in particular isocyanate or melamine crosslinking agents), or curable by input of energy (for example UV light, electron beam curing or heat), for example by means of blocked isocyanates present.
To this end, it is desired that the polymers bonded to the core material contain further reactive groups with which they are subsequently able to react to give a three-dimensionally crosslinked polymer. These can be, for example, unsaturated groups, such as acrylic or vinyl, or also groups which are able to react with an external crosslinking agent, such as, for example, epoxide groups, NH, COOH, alkoxysilyl or OH groups, which may be cross-linked with isocyanates. The functional group is in particular an OH group.

In a preferred embodiment of the present invention, the surface of the cores is coated with at least one surface modifier which contains at least one functional group selected from the group consisting of thiols, sulfides, disulfides and polysulfides. The cores modified in this way are then reacted, in a second step, in a free-radical polymerisation in the presence of organic monomers, where the surface modifier applied in the first step functions as free-radical chain-transfer agent. A polymer chain growing by means of free radicals can, for example, abstract the hydrogen from an SH group and thus generates a new free radical on the sulfur, which is capable of initiating a new polymer chain.

A particularly preferred adhesive according to the invention is characterised in that it is an epoxy adhesive, and the core/shell particles carry a shell comprising oligo- or polyacrylate units, where at least some of the acrylate units have epoxy functions.

Another particularly preferred adhesive is characterised in that it is a polyurethane adhesive, and the core/shell particles carry a shell comprising oligo- or polyacrylate units, where at least some of the acrylate units have OH functions.

Processes for the preparation of the preferred adhesives containing surface modifiers bonded to the surface of the cores comprise the steps of

a) application of at least one surface modifier, where at least one surface modifier contains at least one functional group, to cores dispersed in a solvent, and
b) free-radical polymerisation in the presence of organic monomers, where the surface modifier containing at least one functional group applied in step a) functions as free-radical chain-transfer agent,
c) if necessary work-up of the adhesive prepared in accordance with the invention by distillation, precipitation, solvent exchange, extraction or chromatography.
The surface modifier employed in the processes according to the invention particularly preferably contains at least one functional group selected from the group consisting of thiols, sulfides, disulfides and polysulfides.

In principle, all ways of initiating the free-radical polymerisation that are known to the person skilled in the art are suitable. The free-radical polymerisation is preferably initiated in a manner known to the person skilled in the art using AIBN or AIBN derivatives.

All process types known to the person skilled in the art are likewise suitable for carrying out the polymerisation. For example, the monomers and the free-radical initiator can be added in one step, which is the preferred embodiment. Furthermore, it is also possible for the monomers and the free-radical initiator to be added stepwise, for example with post-initiation and addition of the monomers in portions. It is furthermore also possible to modify the monomer composition stepwise in the course of the polymerisation, for example by time-controlled addition firstly of hydrophilic monomers, then hydrophobic monomers, or vice versa. This is possible, in particular, on use of a controlled free-radical polymerisation process known to the person skilled in the art.

The above-mentioned solvent or solvent mixture is selected from water, organic solvents and mixtures thereof. If the solvent mixture and monomers are selected in such a way that although the monomers are soluble, the polymers formed therefrom are, however, no longer soluble from a certain chain length, the adhesives according to the invention precipitate out of the reaction mixture. The precipitated adhesives can be separated off from the free polymer present in the reaction medium or from unreacted surface modifiers. This can be carried out by standard methods known to the person skilled in the art. In a preferred embodiment, the polymerisation is carried out in a solvent or solvent mixture in which the monomers are soluble, but the polymers formed are insoluble from a certain chain length. The adhesives consequently precipitate out of the reaction solution. Residual monomers and any unreacted reagents still in solution during the production of the cores or the functionalisation thereof or dissolved by-products can be separated off easily, for example by filtration.

In another process, phase separation is induced at a certain point in time by an external trigger, such as, for example, a change in temperature, addition of salt or addition of a non-solvent. The adhesive synthesis can thus be interrupted at any desired points in time, in order, for example, to control the surface coverage.

The core/shell particles obtainable from the above-mentioned processes are particularly suitable for use in adhesives or as additive to adhesives, as described above. The novel adhesives hardly differ in appearance from conventional adhesives. Furthermore, the handling and processing of the adhesives according to the invention correspond to those of conventional adhesives. Difficulties which exist in the preparation of nanocomposites in accordance with the prior art (dispersion effort, handling of powders) do not arise.

An important side effect in this alternative adhesive approach is possible incorporation of further functions by means of the core/shell particles. Thus, electromagnetic rays can be influenced (UV absorption, IR absorption), catalytic effects can be exerted, inorganic coloured nanopigments can be utilised or, for example, nanophosphors can be used as inorganic core.

The following examples merely illustrate the invention without restricting the scope of protection. In particular, the features, properties and advantages described therein of the defined compound(s) on which the relevant example is based can also be applied to other substances and compounds which are not described in detail, but fall within the scope of protection of the claims, unless indicated otherwise elsewhere.

### EXAMPLES

### Example 1

### Core/Shell Particles for 2-Component Epoxy Adhesives

10 g of glycidyloxy methacrylate, 45 g of methyl methacrylate, 45 g of n-butyl acrylate, 5.7 g of 3-mercaptopropyltrimethoxysilane and 0.48 g of azobisisobutyronitrile are heated under reflux for 17 hours in 200 ml of isopropanol. The batch is cooled to room temperature and added to 167 g of an acidified (pH 2) 30% silica sol (for example 30% Levasil 300/30). 12.5 g of n-propyltrimethoxysilane are added to the batch, which is then stirred at 60° C. for 3 hours. The water/isopropanol mixture is subsequently distilled off under reduced pressure and diluted with 3000 g of epoxy resin (for example Dow D.E.R 331). The material is suitable as construction adhesive, for casting applications and knifing-filler material.

### Example 2

### Core/Shell Particles for Epoxy Resins which Cure on Photoinitiation

The preparation is carried out analogously to Example 1, using 3,4-epoxycyclohexyl methacrylate instead of glycidyloxy methacrylate. The base resin used is a cycloaliphatic epoxy resin, such as, for example, 3,4-epoxycyclohexylmethyl 3′,4′-epoxycyclohexylcarboxylate. Ferrocenium hexafluoroantimonate as photoinitiator is added to the batch in a concentration of 1%. The material is suitable for bonding glass and plastics, also to metals and sealants and casting compositions.

### Example 3

### Core/Shell Particles for PUR Adhesives

33.3 g of a 30% silica sol (Levasil 300/30) adjusted to pH 2 are diluted with 33 g of isopropanol, and 2 g of 3-mercaptopropyltrimethoxysilane are added. The batch is stirred at 60° C. for 6 hours. 2 g of 2-hydroxyethyl methacrylate, 7.2 g of methyl methacrylate, 9.2 g of n-butyl acrylate and 0.48 g of azobisisobutyronitrile are subsequently added, and the mixture is heated under reflux for 17 hours. The water/isopropanol mixture is distilled off under reduced pressure and diluted with the desired amount of polyesterpolyol (for example 300 g of Baycoll AD 1100). The material can be cured using the corresponding amount of polyisocyanate (for example Desmodur RC). Areas of application of this adhesive are, inter alia, housing seals and in the construction sector.

### Example 4

### Core/Shell Particles for Acrylate Adhesives which Cure on Photoinitiation

50 g of methyl methacrylate, 50 g of n-butyl acrylate, 5.7 g of 3-mercaptopropyltrimethoxysilane and 0.48 g of azobisisobutyronitrile are heated under reflux for 17 hours in 200 ml of isopropanol. The batch is cooled to room temperature and added to 167 g of an acidified (pH 2) 30% silica sol (for example Levasil 300/30). 12.5 g of 3-mercaptopropyltrimethoxysilane are added to the batch, which is then stirred at 60° C. for 3 hours. The water/isopropanol mixture is subsequently distilled off under reduced pressure and diluted with the desired amount of acrylate (for example 3000 g of Laromer TPGDA or Sartomer SR399), and 2% of Darocure 1173 are added. The material is used in the bonding of glass and plastic parts.

### Example 5

### Preparation of a Carbon Fibre Composite Material Comprising Core/Shell Particles

10 g of glycidyloxy methacrylate, 45 g of methyl methacrylate, 45 g of n-butyl acrylate, 5.7 g of 3-mercaptopropyltrimethoxysilane and 0.48 g of azobisisobutyronitrile are heated under reflux for 17 hours in 200 ml of isopropanol. The batch is cooled to room temperature and added to 167 g of an acidified (pH 2) 30% silica sol (for example 30% Levasil 300/30). 12.5 g of n-propyltrimethoxysilane are added to the batch, which is then stirred at 60° C. for 3 hours. The water/isopropanol mixture is subsequently distilled off under reduced pressure and diluted with 3000 g of epoxy resin (for example Dow D.E.R 331).

Starting from this masterbatch, various mixtures with the epoxy resin DER 331 are prepared in order to investigate the influence of different amounts of core/shell particles on the mechanical properties of the epoxy resins. To this end, the masterbatch comprising core/shell particles is stirred with DOW DER 311 for 10 minutes in a dissolver at a speed of 1000 rpm in vacuo. The curing agent (Aradur HY2954, cycloaliphatic diamine) is subsequently added under the same conditions, and the mixture is stirred in vacuo for a further 5 minutes. The epoxy resin blocks filled with core/shell particles are cured by running a temperature programme of 8 h at 72° C., followed by 16 h at 122° C., then cooling to room temperature. The fracture toughness of the epoxy resin blocks is measured in accordance with ASTM E399-90 on a Zwick universal test machine. This gave the following result:

| Nanoparticle content/ | |
|---|---|
| % by vol. | Fracture toughness K1c/[MPa m^{1/2}] |
| 0 | 0.50 |
| 1 | 0.58 |
| 2 | 0.64 |
| 5 | 0.74 |
| 19 | 1.28 |

It can be seen that the fracture toughness of the epoxy resin blocks is significantly improved by the incorporation of core/shell particles.

The core/shell-modified epoxy resin can be used before curing in order to wet carbon fibre strands and to produce mouldings therefrom, for example by winding or laying impregnated fibre mats on one another. The carbon fibre composite materials prepared in this way are distinguished by the fact that they will stand particularly high stresses.

1. Adhesive comprising at least one matrix material and core/shell particles comprising cores having a diameter in the range from 1 nm to 1 μm with a shell comprising oligomers and/or polymers.

2. Adhesive according to claim 1, characterised in that the oligomers and/or polymers of the shell are covalently bonded to the surface of the cores.

3. Adhesive according to claim 1, characterised in that the adhesive is a pressure-sensitive adhesive or a contact adhesive.

4. Adhesive according to claim 1, characterised in that it is a hot-melt adhesive or a dispersion adhesive.

5. Adhesive according to claim 1, characterised in that the adhesive is a reactive adhesive or part of a fibre-reinforced plastic.

6. Adhesive according to claim 1, characterised in that the matrix material is a polymer selected from the group consisting of polyacrylates, polymethacrylates, polyoxyalkylenes, polyurethanes, polyesters, polyepoxides, polystyrene, polyethylene, polyvinyl esters, ethylenevinyl acetate copolymers, or a mixture of two or more thereof, or correspondingly polymerisable monomers or oligomers thereof, where preferred matrix materials are polyoxyalkylenes, in particular polyepoxides, and polyurethanes.

7. Adhesive according to claim 1, characterised in that it comprises, as matrix material, an ethylene-vinyl acetate copolymer or a mixture of two or more such copolymers.

8. Adhesive according to claim 1, characterised in that the cores are based on sulfates or carbonates of alkaline-earth metal compounds or on oxides or hydroxides of silicon, titanium, zinc, tin, indium, antimony, aluminium, cerium, cobalt, chromium, nickel, iron, yttrium or zirconium or mixtures thereof, which may optionally be coated with metal oxides or hydroxides, or on metals, such as, for example, Ag, Cu, Fe, Au, Pd, Pt, or alloys coated with metal oxides or hydroxides.

9. Adhesive according to claim 1, characterised in that the cores are selected from SiO₂ particles or are selected from ZnO or cerium oxide particles or TiO₂ particles, which are optionally coated with metal oxides or hydroxides.

10. Adhesive according to claim 1, characterised in that the cores are selected from 3-dimensionally crosslinked organosesquisiloxane structures and metal oxides/hydroxides.

11. Adhesive according to claim 1, characterised in that the cores have diameters, determined by means of particle correlation spectroscopy or a transmission electron microscope, of 1 to 20 nm in at least one dimension, preferably a maximum of 500 nm in a maximum of two dimensions.

12. Adhesive according to claim 1, characterised in that the surface of the core/shell particles has been modified by means of at least one surface modifier.

13. Adhesive according to claim 12, characterised in that at least one surface modifier contains at least one functional group selected from the group consisting of thiols, sulfides, disulfides or polysulfides, epoxides, hydroxides, carboxyl, isocyanate and alkenyl or alkynyl or is selected from the group of organofunctional silanes, quaternary ammonium compounds, carboxylic acids, phosphonates, phosphonium and sulfonium compounds or mixtures thereof.

14. Adhesive according to claim 1, characterised in that the oligomers and/or polymers of the shell are selected from the group consisting of poly(meth)acrylates, polyesters, polyurethanes, polyureas, silicones, polyethers, polyamides, polyimides, or mixtures and hybrids thereof.

15. Adhesive according to claim 1, characterised in that it comprises the core/shell particles in an amount of 0.1 to 50% by weight, preferably in an amount of 1 to 30% by weight, in particular 2 to 20% by weight.

16. Adhesive according to claim 1, characterised in that the core:shell weight ratio of the core/shell particles is in the range from 1:10 to 1:0.1.

17. Adhesive according to claim 1, characterised in that the oligomers and/or polymers of the shell have been functionalised with groups which have at least one chemical function selected from —OH, —SH, —NH₂, —COOH, —NCO, —NCOR, acid anhydrides, epoxides, such as glycidyl ether groups, unsaturated groups, or CH-acidic groups, such as

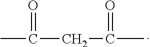

18. Adhesive according to claim 1, characterised in that it is an epoxy adhesive, and the core/shell particles carry a shell comprising oligo- or polyacrylate units, where at least some of the acrylate units have epoxy functions.

19. Adhesive according to claim 1, characterised in that it is a polyurethane adhesive, and the core/shell particles carry a shell comprising oligo- or polyacrylate units, where at least some of the acrylate units have OH functions.

20. Process for the preparation of adhesives according to claim 1, comprising the dispersal of core/shell particles having a diameter of >1 nm in a polymer and optionally solvents or a solvent mixture.

21. A fibre reinforced plastic comprising polymer, fibers, and an adhesive according to claim 1, to promote adhesion between fibers.
